(19) United States
(12) Patent Application Publication
(10) Pub. No.: US 2025/0035814 A1
(43) Pub. Date: Jan. 30, 2025

(54) SUBSURFACE REGION MODELING THAT HONORS CONSTRAINTS ON AND CORRELATIONS BETWEEN SUBSURFACE PROPERTIES

(71) Applicant: Chevron U.S.A. Inc., San Ramon, CA (US)

(72) Inventors: Lewis Li, Houston, TX (US); Jaime Ricardo Vargas, Houston, TX (US); Shahzad Ali Khan, Katy, TX (US); Lianshuang Qi, Sugar Land, TX (US)

(21) Appl. No.: 18/361,406

(22) Filed: Jul. 28, 2023

(51) Int. Cl. G01V 99/00

(52) U.S. Cl. CPC G01V 20/00

(57) ABSTRACT

A multivariate modeling tool utilizes reversible transformations to transform subsurface properties of wells into a modeling space in which the subsurface properties are decorrelated and unconstrained. The subsurface properties of a region are independently propagated from the well(s) in the modeling space. Reverse transformations are applied to the subsurface properties in the modeling space to generate a subsurface representation for the region. The subsurface representation honors constraints on the subsurface properties and correlations between the subsurface properties.

### FIELD

The present disclosure relates generally to the field of modeling subsurface regions using decorrelated subsurface properties.

### BACKGROUND

Bivariate modeling may be used to model correlated properties in a subsurface region. However, the use of bivariate modeling to model more than two properties with higher order correlations and other constraints, such as summation to unity in mineralogy proportions, may be time consuming and result in inconsistent modeling results.

### SUMMARY

This disclosure relates to modeling subsurface regions. Well information and/or other information may be obtained. The well information may characterize subsurface configuration of a well within a region of interest using subsurface properties. The subsurface properties may be correlated. Decorrelated well information may be generated based on transformation of the well information. The decorrelated well information may characterize the subsurface configuration of the well within the region of interest using decorrelated subsurface properties. The decorrelated subsurface properties may not be correlated. A subsurface representation for the region of interest may be generated based on the decorrelated subsurface properties and/or other information. The subsurface representation may honor a mineralogy proportions constraint on the subsurface properties and correlations between the subsurface properties.

A system for modeling subsurface regions may include one or more electronic storage, one or more processors and/or other components. The electronic storage may store information relating to a region of interest, information relating to a well, well information, information relating to subsurface properties, decorrelated well information, information relating to decorrelated subsurface properties, information relating to constraints on the subsurface properties, information relating to correlations between the subsurface properties, information relating to a subsurface representation, and/or other information.

The processor(s) may be configured by machine-readable instructions. Executing the machine-readable instructions may cause the processor(s) to facilitate modeling subsurface regions. The machine-readable instructions may include one or more computer program components. The computer program components may include one or more of a well component, a decorrelation component, a subsurface representation component, and/or other computer program components.

The well component may be configured to obtain well information and/or other information. The well information may characterize subsurface configuration of a well within a region of interest using subsurface properties. The subsurface properties may be correlated.

In some implementations, the region of interest may include an unconventional reservoir. In some implementations, the subsurface properties may include compositional subsurface properties and non-compositional subsurface properties.

The decorrelation component may be configured to generate decorrelated well information. The decorrelated well information may be generated based on transformation of the well information and/or other information. The decorrelated well information may characterize the subsurface configuration of the well within the region of interest using decorrelated subsurface properties. The decorrelated subsurface properties may not be correlated.

In some implementations, the transformation of the well information to generate the decorrelated well information may include: a transformation of the compositional subsurface properties to change distribution of the compositional subsurface properties; and a transformation of the transformed compositional subsurface properties and the non-compositional subsurface properties to decorrelate the transformed compositional subsurface properties and the non-compositional subsurface properties.

The subsurface representation component may be configured to generate a subsurface representation for the region of interest. The subsurface representation for the region of interest may be generated based on the decorrelated subsurface properties and/or other information. The subsurface representation may honor a mineralogy proportions constraint on the subsurface properties and correlations between the subsurface properties.

In some implementations, the mineralogy proportions constraint on the subsurface properties may require the compositional subsurface properties to sum to one.

In some implementations, the generation of the subsurface representation for the region of interest based on the decorrelated subsurface properties may include independent propagation of individual ones of the decorrelated subsurface properties. The generation of the subsurface representation for the region of interest may further include inverse transformation of the propagated, decorrelated subsurface properties.

The inverse transformation of the propagated, decorrelated subsurface properties may include: an inverse transformation of the propagated, decorrelated subsurface properties to correlate the propagated, decorrelated subsurface properties; and an inverse transformation of compositional subsurface properties in the propagated, correlated subsurface properties to restore distribution of the compositional subsurface properties.

In some implementations, the subsurface representation for the region of interest may be generated further based on one or more secondary subsurface properties away from the well. The secondary subsurface propert(ies) may be iteratively modeled in sequence using a weighted average of the secondary subsurface propert(ies) and a modeled subsurface property.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for modeling subsurface regions.

FIG. 2 illustrates an example method for modeling subsurface regions.

FIG. 3 illustrates an example bivariate modeling of subsurface properties.

FIG. 4 illustrates an example flow diagram for modeling subsurface regions using decorrelated subsurface properties.

FIG. 5 illustrates an example flow diagram for incorporating secondary data in modeling subsurface regions.

FIG. 6A illustrates example modeling results in which correlations between subsurface properties are not preserved.

FIG. 6B illustrates example modeling results in which correlations between subsurface properties are preserved.

### DETAILED DESCRIPTION

The present disclosure relates to modeling subsurface regions. A multivariate modeling tool utilizes reversible transformations to transform subsurface properties of wells into a modeling space in which the subsurface properties are decorrelated and unconstrained. The subsurface properties of a region are independently propagated from the well(s) in the modeling space. Reverse transformations are applied to the subsurface properties in the modeling space to generate a subsurface representation for the region. The subsurface representation honors constraints on the subsurface properties and correlations between the subsurface properties.

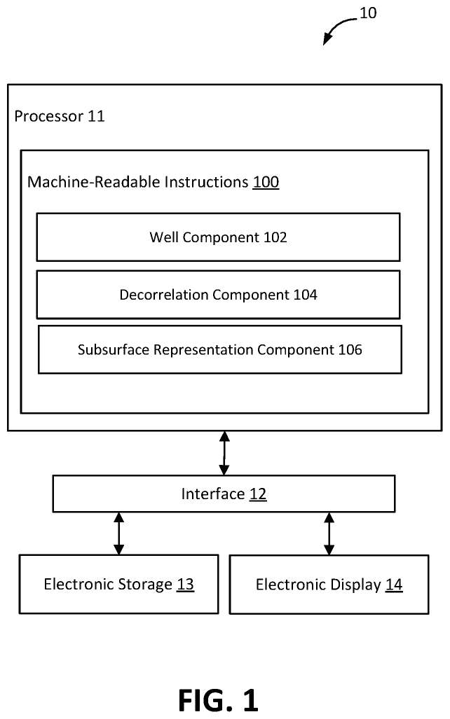

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, and/or other components. Well information and/or other information may be obtained by the processor 11. The well information may characterize subsurface configuration of a well within a region of interest using subsurface properties. The subsurface properties may be correlated. Decorrelated well information may be generated by the processor 11 based on transformation of the well information. The decorrelated well information may characterize the subsurface configuration of the well within the region of interest using decorrelated subsurface properties. The decorrelated subsurface properties may not be correlated. A subsurface representation for the region of interest may be generated based on the decorrelated subsurface properties and/or other information. The subsurface representation may honor a mineralogy proportions constraint on the subsurface properties and correlations between the subsurface properties.

The electronic storage 13 may be configured to include one or more electronic storage media that electronically stores information. The electronic storage 13 may store software algorithms, information determined by the processor 11, information received remotely, and/or other information that enables the system 10 to function properly. For example, the electronic storage 13 may store information relating to a region of interest, information relating to a well, well information, information relating to subsurface properties, decorrelated well information, information relating to decorrelated subsurface properties, information relating to constraints on the subsurface properties, information relating to correlations between the subsurface properties, information relating to a subsurface representation, and/or other information.

The electronic display 14 may refer to an electronic device that provides visual presentation of information. The electronic display 14 may include a color display and/or a non-color display. The electronic display 14 may be configured to visually present information. The electronic display 14 may present information using/within one or more graphical user interfaces. For example, the electronic display 14 may present information relating to a region of interest, information relating to a well, well information, information relating to subsurface properties, decorrelated well information, information relating to decorrelated subsurface properties, information relating to constraints on the subsurface properties, information relating to correlations between the subsurface properties, information relating to a subsurface representation, and/or other information.

Accurately modeling subsurface regions, such as unconventional reservoirs, may require multiple subsurface properties (e.g., petrophysical properties, geomechanical properties) with multivariate correlations and other constraints on subsurface properties, such as summation of mineralogy proportions to unity, to be modeled. Use of classical subsurface modeling methods, such as co-kriging or cloud transform, for such modeling of subsurface regions may be time-consuming and may result in inconsistent modeling results.

Classical subsurface modeling methods may preserve bivariate relationships between subsurface properties. Classical subsurface modeling methods may only be able to honor relationships between two subsurface properties at any given time. This limitation in modeling may cause the modeling result to have inconsistent/geologically inaccurate subsurface properties.

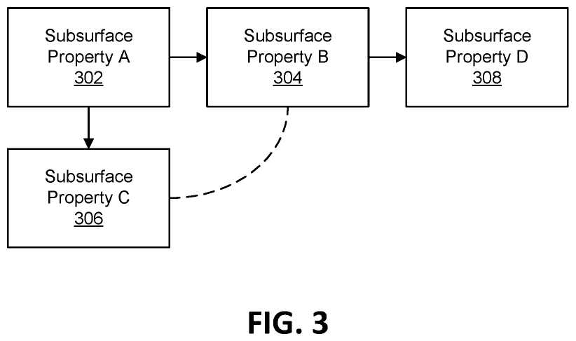

FIG. 3 illustrates an example bivariate modeling of subsurface properties. Values of subsurface property A 302 (e.g., illite percentage) in a subsurface region may be used to model values of subsurface property B 304 (e.g., calcite percentage) in the subsurface region. Values of subsurface property A 302 in the subsurface region may also be used to model values of subsurface property C 306 (e.g., porosity) in the subsurface region. Bivariate modeling may honor (1) the correlation between the subsurface property A 302 and the subsurface property B 304, and (2) the correlation between the subsurface property A 302 and the subsurface property C 306. Such sequential bivariate modeling of subsurface properties may not honor the correlation between the subsurface property B 304 and the subsurface property C 306. That is, the bivariate modeling of the subsurface property B 304 from the subsurface property A 302 and the bivariate modeling of the subsurface property C 306 from the subsurface property A 302 may result in inconsistency between the modeled values of the subsurface property B 304 and the subsurface property C 306. Correction of such inconsistencies may be difficult and time consuming.

Additionally, any error in modeling may be propagated to subsequently modeled subsurface properties. For example, values of the subsurface property B 304 may be used to model values of subsurface property D 308, and errors in the modeled values of the subsurface property B 304 may result in errors in the modeled values of the subsurface property D 308.

Furthermore, other constraints may exist on the subsurface properties. For example, the mineralogy proportions/lithology in a given location in the subsurface region (e.g., a cell within a subsurface representation for the subsurface region) may be required to sum to one. For example, if there are three types of mineral in a given location in the subsurface region, then the modeled percentages of the three types of minerals should sum to one hundred percent. Bivariate modeling of subsurface properties may not honor such constraints. For example, bivariate modeling of three types of minerals may result in the sum of the modeled percentages being less than or more than one hundred percent. As another example, physical constraints may require certain values of subsurface properties. For instance, porosity may need to be greater than zero and mineralogy proportions may need to range between zero and one.

The present disclosure provides a tool to accurate model subsurface regions while honoring multiple correlations between subsurface properties and other constraints on the subsurface properties. The multivariate modeling of the present disclosure enables automated generation of consistent subsurface representations, reduces modeling effort, and enables rapid generation of ensembles of subsurface representations for uncertainty quantification. The multivariate modeling of the present disclosure may utilize a pair of reversible non-linear mappings on conditioning well data to transform the conditioning well data into a new space where the subsurface properties are decorrelated and unconstrained. Individual uncorrelated and unconstrained subsurface properties may be modeled independently, and non-linear mappings may be reserved to map the modeled subsurface properties back into the real world space. Since the mapping accounts for multiple correlations between subsurface properties and any constraints on the subsurface properties, the resulting subsurface representation may automatically honor multiple correlations between subsurface properties and constraints on the subsurface properties. The subsurface properties of the resulting subsurface representation may be consistent.

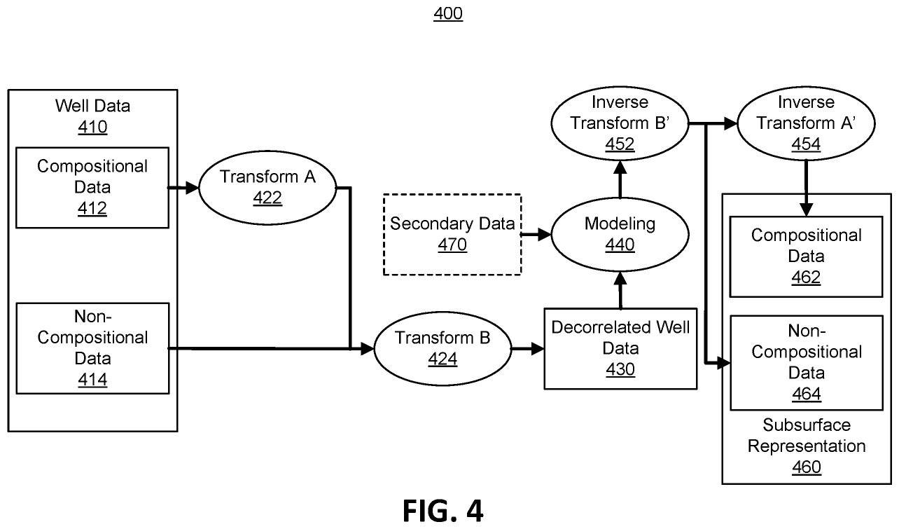

FIG. 4 illustrates an example flow diagram 400 for modeling subsurface regions using decorrelated subsurface properties. Well data 410 may be obtained from one or more wells in a subsurface region. The well data 410 may include compositional data 412, non-compositional data 414, and/or other data. The compositional data 412 may include data on subsurface properties with a mineralogy proportions constraint (e.g., requirement that the mineralogy proportions at a given location/cell sum to one). The non-compositional data 414 may include data on other subsurface properties.

Automatic well data imputation may be performed on the well data 410. Automatic well data imputation may ensure that values of subsurface properties are available at all locations along the well(s). If values of subsurface properties are missing at one or more locations along a well, the missing values may be filled in (e.g., using interpolation of values at surrounding locations) or the well may be removed from the well data 410. The decision to interpolate the missing values or to delete the well may be made based on how much values of subsurface properties are missing from the well. For example, based on more than a threshold amount of values missing from the well, the well may be removed from the well data 410. Based on less than a threshold amount of values missing from the well, the missing values may be interpolated.

Transformation A 422 may be applied to the compositional data 412. The transformation A 422 may change the distribution of the compositional data 412 and flatten the compositional data 412. For example, an isometric log-ratio transformation may be applied to the compositional data 412 to map the values of subsurface properties with the mineralogy proportions constraint into an Aitchison geometry, where the mineralogy proportions constraint is automatically preserved. In the Aitchison geometry, all valid values of the subsurface properties may automatically honor the mineralogy proportions constraint. Use of other transformation to honor the constraints on the subsurface properties is contemplated.

Before transformation B 424 is applied, multivariate cloud densification may be performed to increase the number of values/samples in the data. With increasing dimensions, the space may become sparser with the same number of datapoints. The space may become so sparse that it may not be possible to generate a meaningful shape from the existing datapoints. The multivariate cloud densification may increase the number of datapoints while honoring correlations between the datapoints. For example, a multivariate non-parametric Gibbs sampler may be applied to sample the existing datapoints and add datapoints while preserving the existing distribution. Use of other methods to increase the number of datapoints is contemplated.

The transformation B 424 may be applied to (1) the results of the transformation A 422 on the compositional data 412, and (2) the non-compositional data 414 to generate decorrelated well data 430. The transformation B 424 may decorrelate the subsurface properties. The transformation B 424 may decorrelate the compositional subsurface properties (transformed via the transformation A 422) and the non-compositional subsurface properties. The subsurface properties in in the decorrelated well data 430 may be decorrelated.

For example, a projection pursuit multivariate transformation may be applied to the (1) the results of the transformation A 422 on the compositional data 412, and (2) the non-compositional data 414 to map the data into a modeling space. In the modeling space, all correlations between the values of subsurface properties may be eliminated. The mapping of the transformation B 424 may make variables for subsurface modeling independent of each other. Use of other transformation to decorrelate the subsurface properties is contemplated.

The decorrelated well data 430 may be used to perform modeling 440. After the transformation A 422 and the transformation B 424 have been applied to transform the well data 310 into a new space where the subsurface properties are decorrelated and unconstrained, individual subsurface properties may be modeled independently. For example, individual subsurface properties may be modeled independently using one or more univariate modeling methods, such as kriging or sequential Gaussian simulation. The result(s)/realization(s) of the modeling 410 may be re-mapped back to the original domain of the well data 410 by reversing the transformation A 422 and the transformation B 424.

Inverse transformation B′ 452 may be applied to the modeling result(s)/realization(s) to reverse the transformation B 424 and restore correlations between the subsurface properties. To generate non-compositional data 464 of a subsurface representation 460 for the subsurface region, inverse transformation B′ 452 may be applied to the non-compositional subsurface properties of the modeling result(s)/realization(s). To generate compositional data 462 of the subsurface representation 460, the inverse transformation B′ 452 and inverse transformation A′ 454 may be applied to the compositional subsurface properties of the modeling result(s)/realization(s). The inverse transformation B′ 452 may restore the correlation between the subsurface properties. The inverse transformation A′ 454 may restore the distribution of the compositional subsurface properties and de-flatten the compositional subsurface properties. The compositional data 462 and the non-compositional data 464 of the subsurface representation 460 may honor constraints on the subsurface properties and correlations between the subsurface properties. The distributions of the compositional data 462 and the non-compositional data 464 of the subsurface representation 460 may follow the distributions of the compositional data 412 and the non-compositional data 414 of the well data 410.

Use of other transformations and inverse transformations are contemplated. For example, indicator transformations and inverse indicator transformations may be used when a constraint requires a variable to be categorical.

The process outlined by the flow diagram 400 may include automatic generation of quality control matrices, metrics, and/or plots to determine if human intervention is needed for modeling. One or more quality control matrices, metrics, and/or plots may be generated to provide information on whether correlations between the subsurface properties in the well data 410 are preserved in the subsurface representation 460.

For example, a target correlation matrix may be generated using subsurface properties in the well data 410 to represent the correlation between different subsurface properties in the well data 410. A modeled correlation matrix may be generated using subsurface properties in the subsurface representation 460 to represent the correlation between different subsurface properties in the subsurface representation 460. The target correlation matrix may be compared with the modeled correlation matrix to determine the difference between the correlation between different subsurface properties in the well data 410 and in the subsurface representation 460. One or more alerts may be generated for human intervention in modeling based on the difference between the correlation between different subsurface properties in the well data 410 and in the subsurface representation 460. For example, alert(s) may be generated based on the difference between the correlation between different subsurface properties in the well data 410 and in the subsurface representation 460 being more than a threshold amount.

As another example, one or more metrics may be generated to reflect the correlation between different subsurface properties in the well data 410, the correlation between different subsurface properties in the subsurface representation 460, and/or the difference in correlation between different subsurface properties in the well data 410 and in the subsurface representation 460. One or more alerts may be generated for human intervention in modeling based on the difference between the correlation between different subsurface properties in the well data 410 and in the subsurface representation 460. For example, alert(s) may be generated based on the metric(s) indicating that the difference between the correlation between different subsurface properties in the well data 410 and in the subsurface representation 460 being more than a threshold amount.

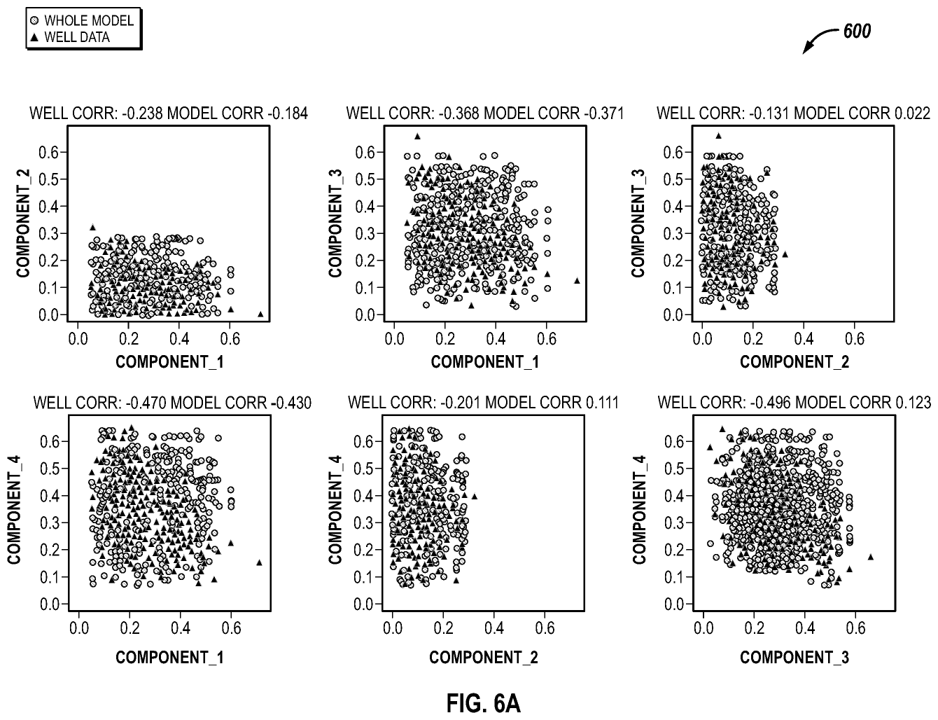

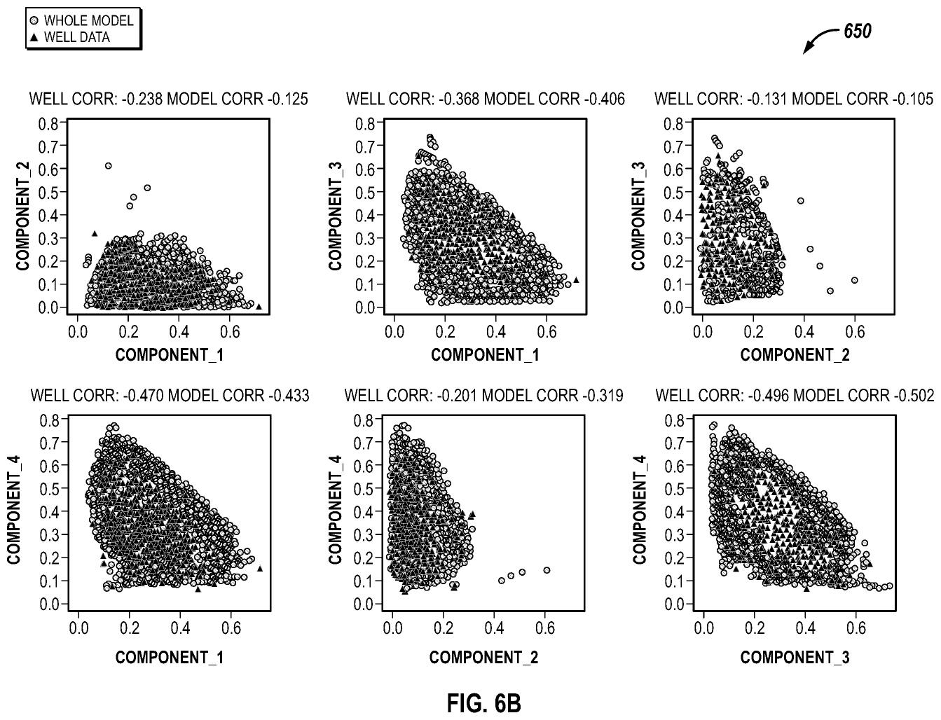

As yet another example, values of subsurface properties in the well data 410 may be plotted against each other and values of subsurface properties in the subsurface representation 460 may be plotted against each other, such as shown in FIGS. 6A and 6B (described below). The plots for the well data 410 may be compared with the plots for the subsurface representation 460 to determine the difference between the correlation between different subsurface properties in the well data 410 and in the subsurface representation 460. The shapes of the plots may be used to determine the difference between the correlation between different subsurface properties in the well data 410 and in the subsurface representation 460. For example, if the shapes of the plots for the well data 410 are preserved in the plots for the subsurface representation 460 (e.g., difference in shapes of the plots are less than a threshold amount), the correlation between the subsurface properties in the well data 410 may be preserved in the subsurface representation 460. If the shapes of the plots for the well data 410 are not preserved in the plots for the subsurface representation 460 (e.g., difference in shapes of the plots are more than a threshold amount, the correlation between the subsurface properties in the well data 410 may not be preserved in the subsurface representation 460. One or more alerts may be generated for human intervention in modeling based on the difference in shapes of the plots for the well data 510 and the subsurface representation 460. For example, alert(s) may be generated based on the difference in shapes of the plots for the well data 510 and the subsurface representation 460 being more than a threshold amount.

In some implementations, secondary data 470 may be incorporated into the modeling 440. Secondary data 470 may refer to subsurface data to be used in modeling subsurface region but cannot be directly incorporated into the transformations (the transform A 422, the transform B 424, the inverse transform B′ 452, the inverse transform A′ 454). For example, the secondary data 470 may include seismic/acoustic impedance data and/or grain size data. The secondary data 470 may exist for locations of the well(s) and other locations in the subsurface region. The secondary data 470 may be incorporated into the modeling 440 via linear combination of existing data. One or more machine learning-based approaches may be utilized.

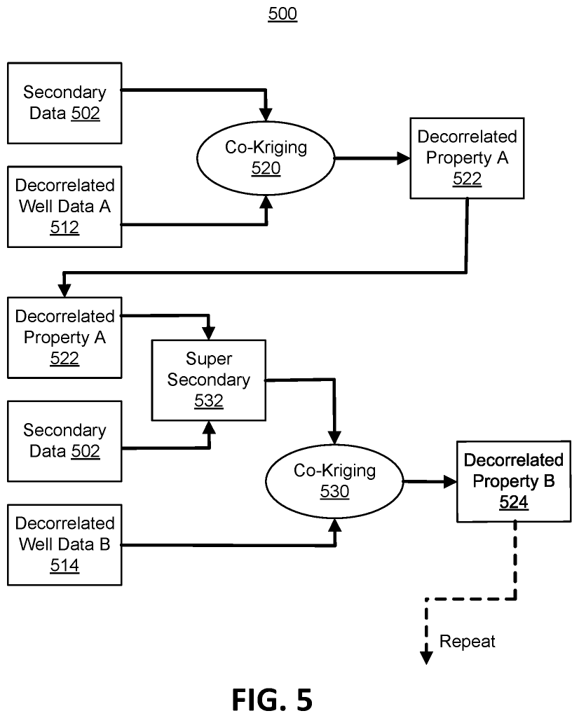

FIG. 5 illustrates an example flow diagram 500 for incorporating secondary data in modeling subsurface regions. In the flow diagram 500, secondary subsurface propert(ies) may be iteratively modeled in sequence using a weighted average of the secondary subsurface propert(ies) and a modeled subsurface property. The sequential incorporation of the secondary subsurface propert(ies) may be performed in the modeling space. The secondary subsurface propert(ies) may be incorporated while (1) preserving correlation between secondary subsurface properties and other subsurface properties, and (2) preserving correlation between the subsurface properties. Individual subsurface properties may be modeled using co-kringing using a super-secondary property. The super-secondary property may be a weighted combination e.g., average) of previously modeled subsurface propert(ies) and the secondary subsurface propert(ies). The weights assigned to the previously modeled subsurface propert(ies) and the secondary subsurface propert(ies) may be determined based on correlation between all the properties. The correlation between the previously modeled subsurface propert(ies) and the secondary subsurface propert(ies) may be artificially lowered to prevent over correlation between the subsurface properties. The modeling using the secondary subsurface propert(ies) may be repeated until all subsurface propert(ies) have been modeled.

For example, in FIG. 5, a decorrelated property A 522 may be modeled using co-kriging 520 with secondary data 502 and decorrelated well data A 512. The decorrelated property A 522 may then be combined with the secondary data 502 into a super secondary 532. That is, a simulated property of the subsurface region may be combined with the secondary data 502 of the subsurface region. A linear combination may be used to generate the super secondary 532, with the amounts of weight given to the decorrelated property A 522 and the secondary data 502 determined based on correlation between the subsurface properties. A decorrelated property B 524 is then modeled using co-kriging 530 with the super secondary 532 and decorrelated well data B 514. This process is repeated for each subsurface property to be modeled.

FIG. 6A illustrates example modeling results in which correlations between subsurface properties are not preserved. FIG. 6A shows plots 600 of well data and modeled data, with the modeled data generated using bivariate modeling. As shown in FIG. 6A, the shapes of the well data are not preserved by the modeled data. Correlations between different subsurface properties in the well data are also not preserved by the modeled data. For example, the average difference in correlation values between the well data and modeled data is 0.197 and the largest difference in correlation value between the well data and modeled data is 0.619 (bottom right plot).

FIG. 6B illustrates example modeling results in which correlations between subsurface properties are preserved. FIG. 6B shows plots 650 of well data and modeled data, with the modeled data generated using multivariate modeling of the present disclosure. As shown in FIG. 6B, the shapes of well data are preserved by the modeled data. Correlations between different subsurface properties in the well data are also preserved by the modeled data. For example, the average difference in correlation values between the well data and modeled data is 0.056 and the largest difference in correlation value between the well data and the modeled data is 0.118 (bottom middle plot.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate modeling subsurface regions. The machine-readable instructions 100 may include one or more computer program components. The machine-readable instructions 100 may include one or more of a well component 102, a decorrelation component 104, a subsurface representation component 106, and/or other computer program components.

The well component 102 may be configured to obtain well information and/or other information. Obtaining well information may include one or more of accessing, acquiring, analyzing, creating, determining, examining, generating, identifying, loading, locating, opening, receiving, retrieving, reviewing, selecting, storing, utilizing, and/or otherwise obtaining the well information. The well component 104 may obtain well information from one or more locations. For example, the well component 104 may obtain well information from a storage location, such as the electronic storage 13, electronic storage of a device accessible via a network, and/or other locations. The well component 104 may obtain well information from one or more hardware components (e.g., a computing device, a component of a computing device) and/or one or more software components (e.g., software running on a computing device). Well information may be stored within a single file or multiple files.

The well information may characterize subsurface configuration of one or more wells within a region of interest. A region of interest may refer to a region of earth that is of interest. For example, a region of interest may refer to a subsurface region (a part of earth located beneath the surface/located underground) for which modeling is desired to be performed. A region of interest may include one or more wells. For example, the region of interest may include an unconventional reservoir with one or more wells. Other types of regions of interest are contemplated.

A well may refer to a hole or a tunnel in the ground. A well may be drilled in one or more directions. For example, a well may be a vertical well, a horizontal well, a deviated well, and/or other type of well. A well may include one or more vertical sections, one or more horizontal sections, and/or other types of sections. A well may be drilled in the ground for exploration and/or recovery of natural resources in the ground. For example, a well may be drilled in the ground to aid in extraction of petrochemical fluid (e.g., oil, gas, petroleum, fossil fuel). Application of the present disclosure to other types of wells and wells drilled for other purposes are contemplated.

Subsurface configuration of a well may refer to attribute, quality, and/or characteristics of the well. Subsurface configuration of a well may refer to type, property, and/or physical arrangement of materials (e.g., subsurface elements) within the well and/or surrounding the well. Examples of subsurface configuration may include types of subsurface materials, characteristics of subsurface materials, compositions of subsurface materials, arrangements/configurations of subsurface materials, physics of subsurface materials, and/or other subsurface configuration. For instance, subsurface configuration may include and/or define types, shapes, and/or properties of materials and/or layers that form subsurface (e.g., geological, petrophysical, geophysical, stratigraphic) structures.

The well information may characterize subsurface configuration of a well using subsurface properties. A subsurface property may refer to property (e.g., attribute, characteristic, quality, trait) of materials in a subsurface region. Subsurface properties may include one or more geological, petrophysical, geomechanical, geophysical, stratigraphic, and/or other subsurface properties. Subsurface properties may include compositional subsurface properties and non-compositional subsurface properties.

Compositional subsurface properties may refer to subsurface properties relating to the composition of materials in a subsurface region. Compositional subsurface properties may refer to subsurface properties with a mineralogy proportions constraint. The mineralogy proportions constraint may require the mineralogy proportions at a given location in the subsurface region to sum to one. The mineralogy proportions constraint may require the mineralogy proportions at a given cell in a subsurface representation for the subsurface region to sum to one. The mineralogy proportions constraint may require the compositional subsurface properties to sum to one. Examples of compositional subsurface properties may include type/make-up of subsurface materials (e.g., calcite, illite, pyrite, kerogen, quartz, oil, free water, bound water). Other types of compositional subsurface properties are contemplated.

Non-compositional subsurface properties may refer to subsurface properties not relating to the composition of materials in a subsurface region. Non-compositional subsurface properties may refer to subsurface properties to which the mineralogy proportions constraint is not applicable. Non-compositional subsurface properties may have one or more physical constraints. A physical constraint may require certain values of subsurface properties (e.g., porosity needs to be greater than zero). Examples of non-compositional subsurface properties may include porosity, permeability, and water saturation. One or more transformations may be designed to honor the physical constraint. For example, one or more transformation may include built-in clipping so that generated values do not fall below a minimum value and/or rise above a maximum value. Other types of non-compositional subsurface properties are contemplated.

The subsurface properties may be correlated. A subsurface property may be correlated with one or more other subsurface properties. A compositional subsurface property may be correlated with one or more other compositional subsurface properties and/or one or more non-compositional subsurface properties. A non-compositional subsurface property may be correlated with one or more other non-compositional subsurface properties and/or one or more compositional subsurface properties. Correlation may exist between different types of compositional subsurface properties, between different types of non-compositional subsurface properties, and/or between compositional subsurface properties and non-compositional subsurface properties.

A correlation between subsurface properties may refer to relationship or connection between the subsurface properties. A correlation between subsurface properties may refer to relationship or connection between the subsurface properties that should be preserved during modeling of subsurface properties. A correlation between subsurface properties may refer to relationship or connection between the subsurface properties that should be preserved within a subsurface representation of a subsurface region.

A correlation between subsurface properties may refer to consistency in values between the subsurface properties. A correlation between subsurface properties may refer to value(s) of one or more subsurface properties being geologically consistent with value(s) of one or more other subsurface properties. For example, a high value of one subsurface property may be consistent with a high value or a low value of another subsurface property. As another example, an increase in the value of one subsurface property may be consistent with an increase or a decrease in the value of another subsurface property. Other types of correlation between subsurface properties are contemplated.

The subsurface properties may be constrained. One or more compositional subsurface properties and/or one or more non-compositional subsurface properties may be constrained. A constraint on the subsurface properties may refer to a limitation or a restriction on the subsurface properties. A constraint on the subsurface properties may refer to a limitation or a restriction on the subsurface properties that should be preserved during modeling of subsurface properties. A constraint on the subsurface properties may refer to a limitation or a restriction on the subsurface properties that should be preserved within a subsurface representation of a subsurface region. Example constraints on the subsurface properties may include a mineralogy proportions constraint (e.g., mineralogy proportions/lithology required to sum to one), a physical constraint (e.g., positive values of certain subsurface properties required), and/or other constraints.

In some implementations, well data imputation may be performed on the well information. The well data imputation may ensure that values of subsurface properties are available at all locations along the well(s). The well data imputation may fill in one or more missing values of subsurface propert(ies) for a well in the well information. For example, one or more missing values of a subsurface property for a well may be interpolated using neighboring values of the subsurface property. The well data imputation may remove values of subsurface properties for a well from the well information. For example, a well in a subsurface region that is missing more than a threshold amount of values of subsurface properties may be removed from use in modeling the subsurface region.

The well information may characterize subsurface configuration of a well using multiple types of subsurface properties. The well information may characterize subsurface configuration of a well using values of subsurface properties. The subsurface configuration of a well may be characterized by values of subsurface properties as a function of position within the well. The subsurface configuration of a well may be characterized as a function of spatial location (e.g., depth) along the well.

The well information may characterize subsurface configuration of a well by including information that defines, describes, delineates, identifies, is associated with, quantifies, reflects, sets forth, and/or otherwise characterizes one or more of content, quality, attribute, feature, and/or other aspects of the subsurface configuration of the well. For example, the well information may characterize subsurface configuration of a well by including information that makes up the subsurface properties of the well and/or information that is used to identify/determine the subsurface properties of the wells. Other types of well information are contemplated.

In some implementations, the well information may be obtained based on analysis and/or exploration of the well(s). For example, the well information may include and/or be obtained from one or more well logs. The well information may include information determined/extracted from one or more well cores.

The decorrelation component 104 may be configured to generate decorrelated well information. Generating decorrelated well information may include calculating, creating, determining, estimating, producing, quantifying, storing, utilizing, and/or otherwise generating the decorrelated well information. The decorrelated well information may be generated based on transformation of the well information and/or other information. Transformation of the well information may include transformation of the subsurface configuration/subsurface properties of the well(s). Transformation of the well information may include non-linear mapping of the subsurface configuration/subsurface properties of the wells. Reversible transformation may be applied to the well information to generate the decorrelated well information. Transformation may be applied to the well information to decorrelate the well information. Transformation may be applied to the well information to remove one or more constraints on the well information.

The decorrelated well information may be generated based on multiple transformations of the well information and/or other information. More than one transformation may be applied to the well information to generate the decorrelated well information. The same transformation and/or different transformations may be applied to different parts of the well information to generate the decorrelated well information. The decorrelated well information may be generated based on sequential transformations of the well information and/or other information. The transformations may be applied in sequence to same or different parts of the of the well information to generate the decorrelated well information.

The decorrelated well information may characterize subsurface configuration of a well within the region of interest using decorrelated subsurface properties. The decorrelated well information may characterize the subsurface configuration of a well within the region of interest using values of decorrelated subsurface properties. The subsurface configuration of a well may be characterized by values of decorrelated subsurface properties as a function of position within the well. The subsurface configuration of a well may be characterized as a function of spatial location (e.g., depth) along the well.

The decorrelated well information may characterize subsurface configuration of a well by including information that defines, describes, delineates, identifies, is associated with, quantifies, reflects, sets forth, and/or otherwise characterizes one or more of content, quality, attribute, feature, and/or other aspects of the subsurface configuration of the well. For example, the decorrelated well information may characterize subsurface configuration of a well by including information that makes up the decorrelated subsurface properties of the well and/or information that is used to identify/determine the decorrelated subsurface properties of the wells. Other types of decorrelated well information are contemplated.

The decorrelated subsurface properties may not be correlated. Transformation of the well information may remove correlations between the subsurface properties in generating the decorrelated subsurface properties. Transformation of the well information may reversibly remove correlations between the subsurface properties in generating the decorrelated subsurface properties. The decorrelated subsurface properties may be independently modeled without creating inconsistencies between the modeled decorrelated subsurface properties.

The decorrelated subsurface properties may not be constrained. Transformation of the well information may remove constraints on the subsurface properties in generating the decorrelated subsurface properties. Transformation of the well information may reversibly remove constraints on the subsurface properties in generating the decorrelated subsurface properties. The decorrelated subsurface properties may be independently modeled without breaking constraints on the subsurface properties. Transformation of the well information may include built-in clipping to prevent the generated values from falling below a minimum value and/or rising above a maximum value, and ensure that one or more physical constraints are honored.

The transformation of the well information to generate the decorrelated well information may include: (1) a transformation of the compositional subsurface properties to change distribution of the compositional subsurface properties, (2) a transformation of the transformed compositional subsurface properties and the non-compositional subsurface properties to decorrelate the transformed compositional subsurface properties and the non-compositional subsurface properties, and/or other transformations. For example, as shown in FIG. 4, one transformation may be applied (the transform A 422) to just the compositional subsurface properties to change distribution of the compositional subsurface properties, and then another transformation may be applied (the transform B 424) to the transformed composition subsurface properties and the non-compositional subsurface properties to decorrelate the transformed compositional subsurface properties and the non-compositional subsurface properties.

For example, an isometric log ratio transformation may be applied to the compositional subsurface properties to change distribution of the compositional subsurface properties. Scatter plots between compositional subsurface properties may be skewed and make statistical modeling difficult. For example, the values of compositional subsurface properties may be squashed along an axis and make modeling difficult. A log transformation may be applied to pull the values away from the axis and make modeling easier. Application of the isometric log ratio transformation may include flattening of the values of the compositional subsurface properties onto a flat surface. The surface on which all the values of the compositional subsurface properties exist may be calculated and flattened, such as by using Gram-Schmidt Orthonormalization.

The first transformation of the compositional subsurface properties may remove one or more constraints on the compositional subsurface properties (e.g., mineralogy proportions constraint). For example, the isometric log ratio transformation may eliminate constraints on the compositional subsurface properties by switching to a new space where any point in the space is valid with respect to the constraints. For example, the isometric log ratio transformation may eliminate the mineralogy proportions constraint on the compositional subsurface properties by switching to a new space where any point in the space is valid with respect to the mineralogy proportions constraint. Modeling may be performed in this space and reversed to get back to the original space. Use of other bijective transformations to change distribution of the compositional subsurface properties and remove constraints on the compositional subsurface properties is contemplated.

Transformation of the compositional subsurface properties into the new space with higher dimensions may make the compositional subsurface properties sparser. In some implementations, multivariate cloud densification may be performed to increase the number of values/samples in the compositional subsurface properties. The multivariate cloud densification may increase the number of values/samples in the compositional subsurface properties while honoring correlations between the compositional subsurface properties. For example, a multivariate non-parametric Markov chain Monte Carlo (e.g., Gibbs sampler) may be applied to sample the existing values of the compositional subsurface properties and add additional values of the compositional subsurface properties while preserving the existing distribution of the compositional subsurface properties. Use of other methods to increase the number of values is contemplated.

The second transformation of the transformed composition subsurface properties and the non-compositional subsurface properties may remove correlations between the compositional subsurface properties and non-compositional subsurface properties. The reversible mapping of the subsurface properties by the second transformation may make all subsurface properties independent of each other for modeling. For example, a projection pursuit multivariate transformation may be applied to the transformed composition subsurface properties and the non-compositional subsurface properties to map the transformed composition subsurface properties and the non-compositional subsurface properties into a modeling space.

The projection pursuit multivariate transformation may include an iterative process in which (1) distributions of the values of the transformed composition subsurface properties and the non-compositional subsurface properties are analyzed in multiple dimensions to find the dimension along which the distribution is most non-Gaussian, and (2) a transform is applied along that dimension to more closely resemble a normal distribution. For example, in each iteration, the most non-Gaussian slice/projection in the high dimension dataset may be identified, and a normal score transform may be applied along the direction of the most non-Gaussian slice/projection. This one-dimensional transformation may be repeated applied along the direction with the most non-Gaussian distribution until every slice/projection is sufficiently Gaussian. That is, the identification of the direction along which the distribution is most non-Gaussian and transformation along that direction to make it more Gaussian may be repeated until all directions contain distributions which are sufficiently Gaussian (e.g., difference between the distribution and a Gaussian distribution is less than a threshold amount).

The direction along which the transform was applied to make the distribution more Gaussian, and how the transform was applied may be stored and used to reverse the projection pursuit multivariate transform. For example, the slope and/or vector along which the most non-Gaussian distribution is projected (e.g., slice along which normal score transform is applied) and the histogram of the shape before the transform along that direction (e.g., original distribution along the slice) may be stored and used to reverse the projection pursuit multivariate transform. The reversal of the projection pursuit multivariate transform may start from the last iteration of the projection pursuit multivariate transform. The reversal of the projection pursuit multivariate transformation may project the datapoints onto the direction on which the transform was applied, and the datapoints may be reversed back to the original shape.

In the modeling space, all correlations between the transformed composition subsurface properties and the non-compositional subsurface properties may be eliminated. The decorrelated surface properties may have a zero correlation/covariance. The decorrelated surface properties have a n-dimensional Gaussian distribution with zeros in the diagonal of its matrix. Use of other bijective transformations to remove correlations between the subsurface properties is contemplated.

The subsurface representation component 106 may be configured to generate a subsurface representation for the region of interest. Generating a subsurface representation for the region of interest may include calculating, creating, determining, estimating, producing, quantifying, storing, utilizing, and/or otherwise generating the subsurface representation for the region of interest. The subsurface representation for the region of interest may be generated based on the decorrelated subsurface properties and/or other information. The subsurface representation for the region of interest may be generated by performing modeling (e.g., geostatistical modeling) of the subsurface configuration of the region of interest using the decorrelated subsurface properties and/or other information. Performing modeling of the subsurface configuration of the region of interest may include simulating the subsurface configuration of the region of interest. Performing modeling of the subsurface configuration of the region of interest may include simulating the types and/or the values of the subsurface properties of the region of interest.

A subsurface representation may refer to a computer-generated representation of a subsurface region. A subsurface representation may be defined by and/or include the subsurface configuration simulated by one or more subsurface models. A subsurface model may refer to a computer model (e.g., program, tool, script, function, process, algorithm) that generates subsurface representations. A subsurface model may simulate subsurface configuration within a region underneath the surface (subsurface region). A subsurface model may simulate subsurface configuration by generating one or more subsurface representations. A subsurface representation may be representative of a subsurface region in the real world (e.g., an unconventional reservoir in the real world). A subsurface representation may define subsurface configuration of a real subsurface region. A subsurface representation may be representative of a subsurface region in the digital world (e.g., an unconventional reservoir in the digital world). A subsurface representation may define simulated subsurface configuration of a simulated subsurface region.

A subsurface representation may define subsurface configuration at different locations within a subsurface region. A subsurface representation may define (e.g., characterize, describe, identify, quantify, etc.) subsurface configuration of a subsurface region using values of one or more subsurface properties. The subsurface configuration in different portions of the subsurface representation may be defined by values of subsurface propert(ies) in those portions. For example, the subsurface representation may be made up of cells (e.g., voxels), and the cells may include and/or be associated with particular values of subsurface propert(ies). The cells of the subsurface representation may be used to convey information relating to the subsurface propert(ies) in the corresponding portions of the subsurface representation.

The subsurface representation of the region of interest may reflect the likely subsurface configuration within the region of interest. The subsurface representation of the region of interest may be generated for a particular moment in time and/or for a duration of time (e.g., simulation of how subsurface configuration changes within the region of interest over time).

Generation of the subsurface representation using the decorrelated subsurface properties may result in the subsurface representation honoring constraints on the subsurface properties and honoring correlations between the subsurface properties. For example, the subsurface representation generated based on the decorrelated subsurface properties may honor the mineralogy proportions constraint on the subsurface properties, other constraints on the subsurface properties, and correlations between the subsurface properties. The compositional surface properties of the subsurface representation may sum to one. The sum of different types of minerals in individual cells of the subsurface representation may sum to one. The subsurface properties of the subsurface representation may be consistent with each other.

A subsurface representation of the region of interest that honors both constraints on the subsurface properties and correlations between the subsurface properties may more accurately reflect actual subsurface configuration of the region of interest than a subsurface representation of the region of interest that fails to honors constraints on the subsurface properties and/or correlations between the subsurface properties. A subsurface representation of the region of interest that honors both constraints on the subsurface properties and correlations between the subsurface properties may be used to understand/predict the subsurface configuration of the region of interest more accurately than a subsurface representation of the region of interest that fails to honors constraints on the subsurface properties and/or correlations between the subsurface properties. For example, a subsurface representation of the region of interest that honors both constraints on the subsurface properties and correlations between the subsurface properties may be used to predict dynamics within the region of interest more realistically and/or perform more accurate geo-mechanical simulations. Other uses of the subsurface representation of the region of interest are contemplated.

In some implementations, the generation of the subsurface representation for the region of interest based on the decorrelated subsurface properties may include independent propagation of individual ones of the decorrelated subsurface properties. The decorrelated subsurface properties of a well within the region of interest may be propagated out to locations where wells to not exist within the region of interest. The decorrelated subsurface properties of a well within the region of interest may be populated within cells of the subsurface representation, and the empty cells of the subsurface representation may be populated by independently propagating the decorrelated subsurface properties from the cells corresponding to the well. Because the decorrelated subsurface properties are no longer correlated within the modeling space, the decorrelated subsurface may be independently simulated within the subsurface representation without breaking the consistency between the subsurface representation. Separate grids of separate subsurface properties may be independently simulated to generate the subsurface representation.

The generation of the subsurface representation for the region of interest may further include inverse transformation of the decorrelated subsurface properties (the decorrelated subsurface properties of the well(s); the propagated, decorrelated subsurface properties in other locations). The decorrelated subsurface properties of the well(s) within the subsurface representation and the decorrelated subsurface properties that were propagated from the well(s) may be reverted back into the real world space. The inverse transformation of the decorrelated subsurface properties may result in a subsurface representation in the real world space that automatically honors both constraints on the subsurface properties and correlations between the subsurface properties. The inverse transformation of the decorrelated subsurface properties may result in a subsurface representation in the real world space that automatically honors the mineralogy proportions constraint and has subsurface properties that has consistent with each other.

The inverse transformation of the decorrelated subsurface properties may include multiple inverse transformations of the decorrelated subsurface properties. The same inverse transformation and/or different inverse transformations may be applied to different decorrelated subsurface properties. The inverse transformation of the decorrelated subsurface properties may include sequential inverse transformation of the decorrelated subsurface properties. The inverse transformations may be applied in sequence to same or different decorrelated subsurface properties.

The inverse transformation of the decorrelated subsurface properties may include: (1) an inverse transformation of the decorrelated subsurface properties to correlate the decorrelated subsurface properties; (2) an inverse transformation of compositional subsurface properties in the correlated subsurface properties to restore distribution of the compositional subsurface properties, and/or other inverse transformations. For example, as shown in FIG. 4, one inverse transformation may be applied (the inverse transform B′ 452) to the result of the modeling 440 to correlate the decorrelated subsurface properties, and then another inverse transformation may be applied (the inverse transform A′ 454) to the just the compositional subsurface properties to restore the distribution of the compositional subsurface properties and de-flatten the compositional subsurface properties.

For example, an inverse projection pursuit multivariate transformation may be applied to the decorrelated subsurface properties to undo the projection pursuit multivariate transformation and restore the correlations between the compositional subsurface properties and non-compositional subsurface properties. An inverse projection pursuit multivariate transformation may be applied to the decorrelated subsurface properties to remap the compositional subsurface properties and non-compositional subsurface properties from the modeling space to the real world space.

As another example, an inverse isometric log ratio transformation may be applied to the compositional subsurface properties to undo the isometric log ratio transformation and restore the distribution of the compositional subsurface properties. An inverse isometric log ratio transformation may be applied to the compositional subsurface properties to de-flatten the compositional subsurface properties and restore the constraints on the compositional subsurface properties. Use of other inverse transformations are contemplated.

In some implementations, the subsurface representation for the region of interest may be generated further based on one or more secondary subsurface properties away from the well. A secondary subsurface property may refer to subsurface property to be used in modeling subsurface region but cannot be directly incorporated into the transformations. Values of secondary subsurface propert(ies) may be obtained from locations along the well(s) and other locations within the region of interest. Examples of secondary subsurface properties include seismic derived subsurface properties, such as acoustic impedance, and grain size.

The secondary subsurface propert(ies) may be iteratively modeled in sequence using a weighted average of the secondary subsurface propert(ies) and a modeled subsurface property. For example, the secondary subsurface propert(ies) may be iteratively modeled in sequence using a weighted average of the secondary subsurface propert(ies) and a modeled subsurface property as described with respect to FIG. 5. Other incorporation of the secondary subsurface properties in generation of the subsurface representation is contemplated.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a non-transitory, tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

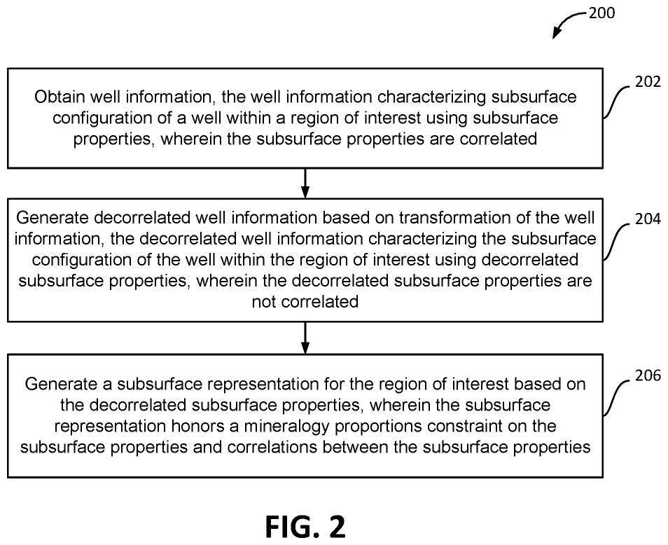

FIG. 2 illustrates a method 200 for modeling subsurface regions. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, well information and/or other information may be obtained. The well information may characterize subsurface configuration of a well within a region of interest using subsurface properties. The subsurface properties may be correlated. In some implementations, operation 202 may be performed by a processor component the same as or similar to the well component 102 (Shown in FIG. 1 and described herein).

At operation 204, decorrelated well information may be generated based on transformation of the well information. The decorrelated well information may characterize the subsurface configuration of the well within the region of interest using decorrelated subsurface properties. The decorrelated subsurface properties may not be correlated. In some implementations, operation 204 may be performed by a processor component the same as or similar to the decorrelation component 104 (Shown in FIG. 1 and described herein).

At operation 206, a subsurface representation for the region of interest may be generated based on the decorrelated subsurface properties and/or other information. The subsurface representation may honor a mineralogy proportions constraint on the subsurface properties and correlations between the subsurface properties. In some implementations, operation 206 may be performed by a processor component the same as or similar to the subsurface representation component 106 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for modeling subsurface regions, the system comprising:
one or more physical processors configured by machine-readable instructions to:
obtain well information, the well information characterizing subsurface configuration of a well within a region of interest using subsurface properties, wherein the subsurface properties are correlated;
generate decorrelated well information based on transformation of the well information, the decorrelated well information characterizing the subsurface configuration of the well within the region of interest using decorrelated subsurface properties, wherein the decorrelated subsurface properties are not correlated; and
generate a subsurface representation for the region of interest based on the decorrelated subsurface properties, wherein the subsurface representation honors a mineralogy proportions constraint on the subsurface properties and correlations between the subsurface properties.

2. The system of claim 1, wherein the region of interest includes an unconventional reservoir.

3. The system of claim 1, wherein the subsurface properties include compositional subsurface properties and non-compositional subsurface properties.

4. The system of claim 3, wherein the mineralogy proportions constraint requires the compositional subsurface properties to sum to one.

5. The system of claim 3, wherein the transformation of the well information to generate the decorrelated well information includes:
a first transformation of the compositional subsurface properties to change distribution of the compositional subsurface properties; and
a second transformation of the transformed compositional subsurface properties and the non-compositional subsurface properties to decorrelate the transformed compositional subsurface properties and the non-compositional subsurface properties.

6. The system of claim 1, wherein the generation of the subsurface representation for the region of interest based on the decorrelated subsurface properties includes independent propagation of individual ones of the decorrelated subsurface properties.

7. The system of claim 6, wherein the generation of the subsurface representation for the region of interest further includes inverse transformation of the propagated, decorrelated subsurface properties.

8. The system of claim 7, wherein the inverse transformation of the propagated, decorrelated subsurface properties includes:
a first inverse transformation of the propagated, decorrelated subsurface properties to correlate the propagated, decorrelated subsurface properties; and
a second inverse transformation of compositional subsurface properties in the propagated, correlated subsurface properties to restore distribution of the compositional subsurface properties.

9. The system of claim 1, wherein the subsurface representation for the region of interest is generated further based on one or more secondary subsurface properties away from the well.

10. The system of claim 9, wherein the one or more secondary subsurface properties are iteratively modeled in sequence using a weighted average of the one or more secondary subsurface properties and a modeled subsurface property.

11. A method for modeling subsurface regions, the method comprising:
obtaining well information, the well information characterizing subsurface configuration of a well within a region of interest using subsurface properties, wherein the subsurface properties are correlated;
generating decorrelated well information based on transformation of the well information, the decorrelated well information characterizing the subsurface configuration of the well within the region of interest using decorrelated subsurface properties, wherein the decorrelated subsurface properties are not correlated; and
generating a subsurface representation for the region of interest based on the decorrelated subsurface properties, wherein the subsurface representation honors a mineralogy proportions constraint on the subsurface properties and correlations between the subsurface properties.

12. The method of claim 11, wherein the region of interest includes an unconventional reservoir.

13. The method of claim 11, wherein the subsurface properties include compositional subsurface properties and non-compositional subsurface properties.

14. The method of claim 13, wherein the mineralogy proportions constraint requires the compositional subsurface properties to sum to one.

15. The method of claim 13, wherein the transformation of the well information to generate the decorrelated well information includes:
a first transformation of the compositional subsurface properties to change distribution of the compositional subsurface properties; and
a second transformation of the transformed compositional subsurface properties and the non-compositional subsurface properties to decorrelate the transformed compositional subsurface properties and the non-compositional subsurface properties.

16. The method of claim 11, wherein generating the subsurface representation for the region of interest based on the decorrelated subsurface properties includes independently propagating individual ones of the decorrelated subsurface properties.

17. The method of claim 16, wherein the generating the subsurface representation for the region of interest further includes inverse transformation of the propagated, decorrelated subsurface properties.

18. The method of claim 17, wherein the inverse transformation of the propagated, decorrelated subsurface properties includes:
a first inverse transformation of the propagated, decorrelated subsurface properties to correlate the propagated, decorrelated subsurface properties; and
a second inverse transformation of compositional subsurface properties in the propagated, correlated subsurface properties to restore distribution of the compositional subsurface properties.

19. The method of claim 11, wherein the subsurface representation for the region of interest is generated further based on one or more secondary subsurface properties away from the well.

20. The method of claim 19, wherein the one or more secondary subsurface properties are iteratively modeled in sequence using a weighted average of the one or more secondary subsurface properties and a modeled subsurface property.
